(19) United States
(12) Patent Application Publication
(10) Pub. No.: US 2017/0061287 A1
(43) Pub. Date: Mar. 2, 2017

(54) FAQs UPDATER AND GENERATOR FOR MULTI-COMMUNICATION CHANNELS

(71) Applicant: International Business Machines Corporation, Armonk, NY (US)

(72) Inventor: Leho Nigul, Richmond Hill (CA)

(21) Appl. No.: 15/053,462

(22) Filed: Feb. 25, 2016

Related U.S. Application Data
(63) Continuation of application No. 14/837,414, filed on Aug. 27, 2015.

(51) Int. Cl. G06N 5/02; G06F 17/30

(52) U.S. Cl. CPC G06N 5/022; G06F 17/30675

(57) ABSTRACT

A method for updating and generating frequently asked questions (FAQs) associated with at least one communication channel is provided. The method may include detecting the at least one communication channel. The method may further include extracting a plurality of FAQs data from the detected at least one communication channel. Additionally, the method may include normalizing the extracted plurality of FAQs data. The method may also include updating and generating a plurality of FAQs based on the extracted plurality of FAQs data. The method may further include communicating the updated and generated plurality of FAQs to the detected at least one communication channel.

### BACKGROUND

The present invention relates generally to the field of computing, and more specifically, to frequently asked questions (FAQs).

Generally, communication tools enable the sharing and processing of information between users. Phones, websites, forums, chat rooms, social networks, instant messaging, email programs, and face to face interaction are some of the communication tools that connects users to information. Typically, these communication tools may include frequently asked questions (FAQs) that relate to specific topics. Specifically, frequently asked questions (FAQs) are lists of questions with answers that are commonly asked by users and typically based on popular topics. Therefore, FAQs are a popular tool for disclosing information that may be of common interest to groups of users. For example, users may access a website such as a medical insurance website. As such, users may want to find information that generally relates to health insurance such as how to sign up for medical coverage, tax information, the different types of medical coverages, and the cost of medical coverages. Therefore, users may typically access a link to frequently asked questions (FAQs) that relate to the information regarding medical coverage that users generally want to discover.

### SUMMARY

A method may include detecting, by a FAQs maintenance program, a website that includes a plurality of frequently asked questions (FAQs) in the form of text query. The FAQs maintenance program may be an application running on a client device via a communications network, and further the FAQs maintenance program may interact with one or more software products. The plurality of FAQs may have been inputted by a plurality of users using the website. The FAQs may include a question and an answer to the question. The method may include extracting the plurality of FAQs from the website. The method may include normalizing, by a FAQs data normalizer, the extracted plurality FAQs. The method may include determining that the plurality of FAQs includes offensive content. The method may include updating, by the FAQs maintenance program, the plurality of FAQs by replacing the offensive content with inoffensive content based on the determining that the plurality of FAQs may include offensive content and further based on historical data from previous updates.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to one embodiment;

FIG. 2 is block diagram illustrative of a FAQs maintenance program 108A, 108B according to one embodiment;

FIG. 3 is an operational flowchart illustrating the steps carried out by a program for updating and generating frequently asked questions (FAQs) associated with at least one communication channel according to one embodiment;

FIG. 4 is a block diagram of the system architecture of a program for updating and generating frequently asked questions (FAQs) associated with at least one communication channel according to one embodiment;

FIG. 5 is a block diagram of an illustrative cloud computing environment including the computer system depicted in FIG. 1, in accordance with an embodiment of the present disclosure; and

FIG. 6 is a block diagram of functional layers of the illustrative cloud computing environment of FIG. 5, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

Embodiments of the present invention relate generally to the field of computing, and more particularly, to frequently asked questions (FAQs). The following described exemplary embodiments provide a system, method and program product for generating and updating frequently asked questions (FAQs). Therefore, the present embodiment has the capacity to improve the technical field associated with frequently asked questions (FAQs) by providing seamless updating for questions and answers associated with the frequently asked questions (FAQs). Specifically, the present embodiment may update questions and provide answers to frequently asked questions (FAQs) related to multichannel communication tools.

As previously described, FAQs are a popular tool for disclosing information that may be of common interest to groups of users. However, the FAQs may become outdated due to such events as changes in policies and/or new information. For example, a website for a retail company may have changes in their return policy. Therefore, FAQs for the website that are related to the company's return policy may need to be updated and generated to reflect the changes to the company's return policy. Typically, such updates to the FAQs are manually done and may generally be inefficient due to time and expense. As such, it may be advantageous, among other things, to provide a system, method and program product for updating and generating frequently asked questions (FAQs) associated with different communication channels. Specifically, existing FAQs and answers on the communication channels may be updated, and FAQs based on new questions posed by users on the communication channels may be generated.

According to at least one implementation of the present embodiment, communication channels may be detected. Then, frequently asked questions (FAQs) data associated with the communication channels may be extracted. Next, the frequently asked questions (FAQs) data may be normalized. Then, the frequently asked questions (FAQs) data may be generated and updated. Next, the updated frequently asked questions (FAQs) and answers may be communicated to the communication channels.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method and program product for generating and updating frequently asked questions (FAQs) associated with multi-communication channels.

According to at least one implementation of the present embodiment, communication channels may be detected. Then, frequently asked questions (FAQs) data associated with the communication channels may be extracted. Next, the frequently asked questions (FAQs) data may be normalized to at least one uniform format. Then, based on the normalized FAQs data, the frequently asked questions (FAQs) may be generated and updated. Next, the generated and updated frequently asked questions (hereinafter FAQs) and answers may be uploaded to the communication channels.

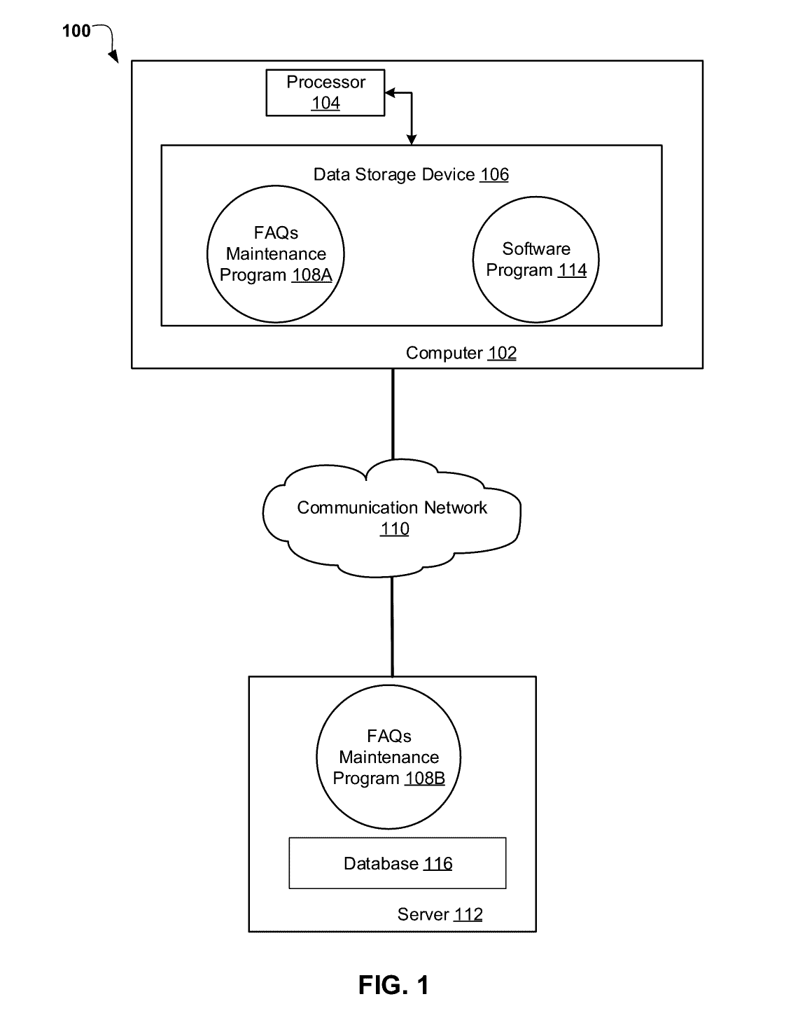

Referring now to FIG. 1, an exemplary networked computer environment 100 in accordance with one embodiment is depicted. The networked computer environment 100 may include a computer 102 with a processor 104 and a data storage device 106 that is enabled to run a FAQs maintenance program 108A and a software program 114. The software program 114 may be an application program such as an internet browser and an email program. The FAQs maintenance program 108A may communicate with the software program 114. The networked computer environment 100 may also include a server 112 that is enabled to run a FAQs maintenance program 108B and a communication network 110. The networked computer environment 100 may include a plurality of computers 102 and servers 112, only one of which is shown for illustrative brevity.

According to at least one implementation, the present embodiment may also include a database 116, which may be running on server 112. The communication network 110 may include various types of communication networks, such as a wide area network (WAN), local area network (LAN), a telecommunication network, a wireless network, a public switched network and/or a satellite network. It may be appreciated that FIG. 1 provides only an illustration of one implementation and does not imply any limitations with regard to the environments in which different embodiments may be implemented. Many modifications to the depicted environments may be made based on design and implementation requirements.

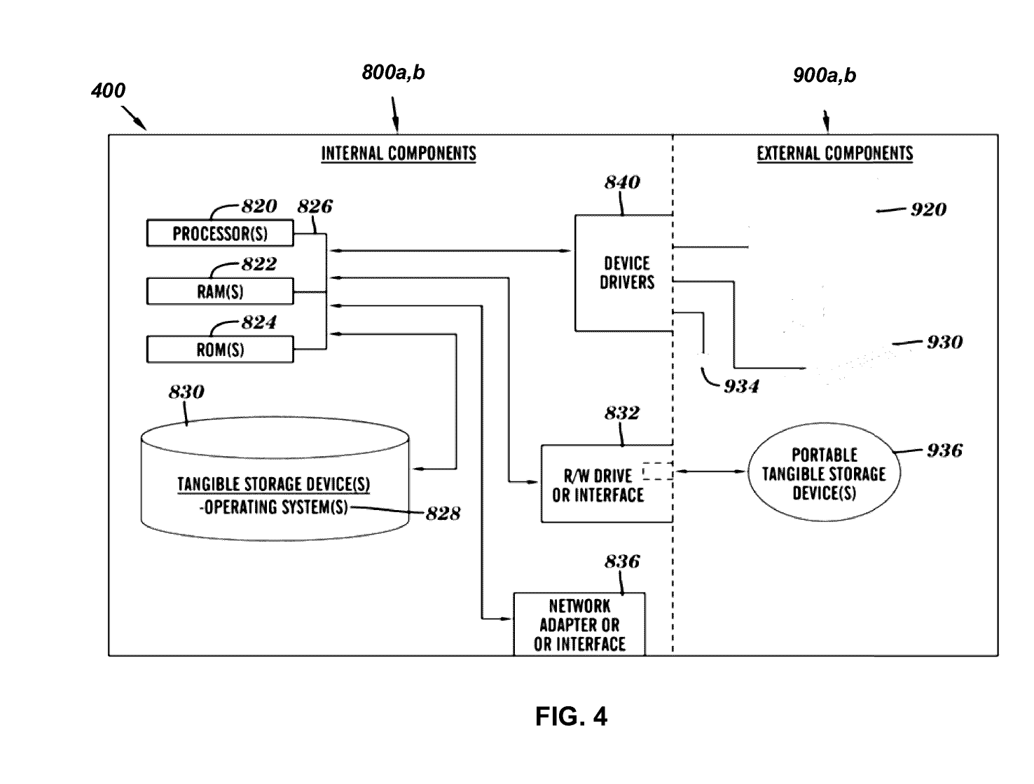

The client computer 102 may communicate with server computer 112 via the communications network 110. The communications network 110 may include connections, such as wire, wireless communication links, or fiber optic cables. As will be discussed with reference to FIG. 4, server computer 112 may include internal components 800a and external components 900a, respectively and client computer 102 may include internal components 800b and external components 900b, respectively. Server computer 112 may also operate in a cloud computing service model, such as Software as a Service (SaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing device capable of running a program and accessing a network. According to various implementations of the present embodiment, the FAQs maintenance program 108A, 108B may interact with a database 116 that may be embedded in various storage devices, such as, but not limited to a mobile device 102, a networked server 112, or a cloud storage service.

According to the present embodiment, a program, such as a FAQs maintenance program 108A and 108B may run on the client computer 102 or on the server computer 112 via a communications network 110. The FAQs maintenance program 108A, 108B may generate and update frequently asked questions (FAQs) and answers. Specifically, a user using a computer, such as computer 102, may run a FAQs maintenance program 108A, 108B, that interacts with a software program 114, such as Firefox® (Firefox and all Firefox—based trademarks and logos are trademarks or registered trademarks of Firefox and/or its affiliates) to update FAQs, generate FAQs, and provide answers to FAQs that are related to multichannel communications.

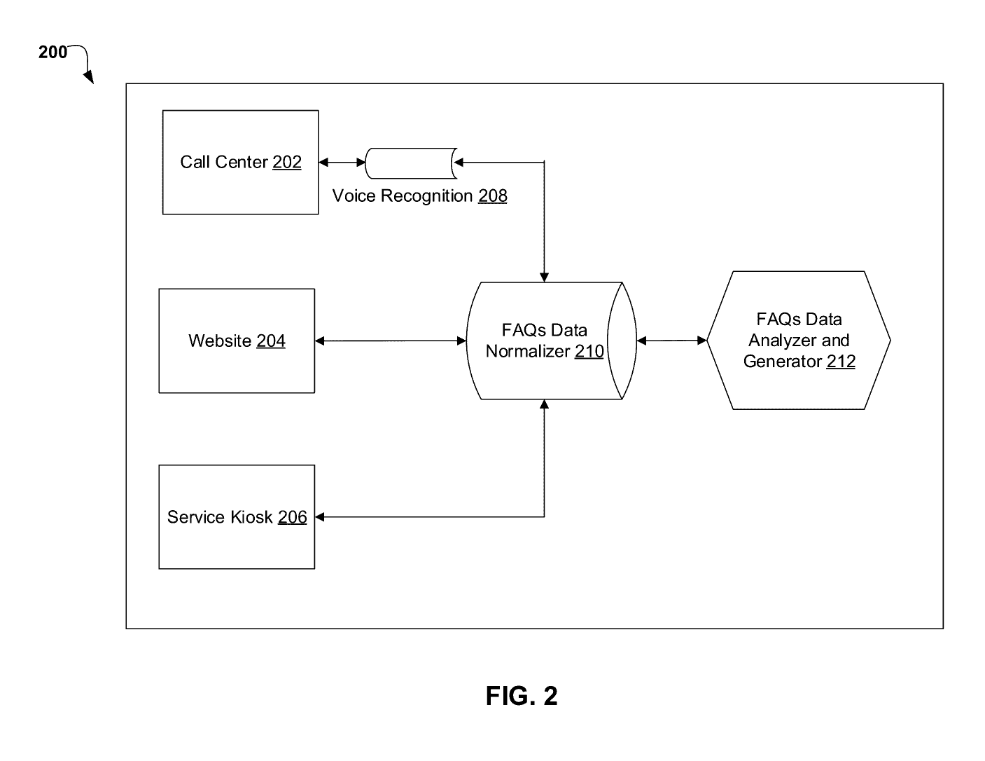

Referring now to FIG. 2, a block diagram 200 illustrative of a FAQs maintenance program 108A, 108B (FIG. 1) in accordance with one embodiment is depicted. As previously described in FIG. 1, the FAQs maintenance program 108A, 108B (FIG. 1) may generate and update FAQs associated with different communication channels. Specifically, the FAQs maintenance program 108A, 108B (FIG. 1) may detect communication channels such as a call center 202, website 204, service kiosk 206, face-to-face interaction, gaming consoles, video consoles, and email applications. Next, the FAQs maintenance program 108A, 108B (FIG. 1) may extract FAQs data associated with the communication channels. Furthermore, the FAQs maintenance program 108A, 108B (FIG. 1) may include voice recognition tool 208 and a FAQs data normalizer 210 to normalize the FAQs data extracted from the communication channels. Thereafter, the FAQs maintenance program 108A, 108B (FIG. 1) may include a FAQs data analyzer and generator 212 to update and generate FAQs based on the extracted FAQs data. Then, the FAQs maintenance program 108A, 108B (FIG. 1) may communicate the updated and generated FAQs data to the different communication channels 202, 204, and 206. Specifically, the FAQs maintenance program 108A, 108B (FIG. 1) may extract the existing FAQs and answers data as well as new questions.

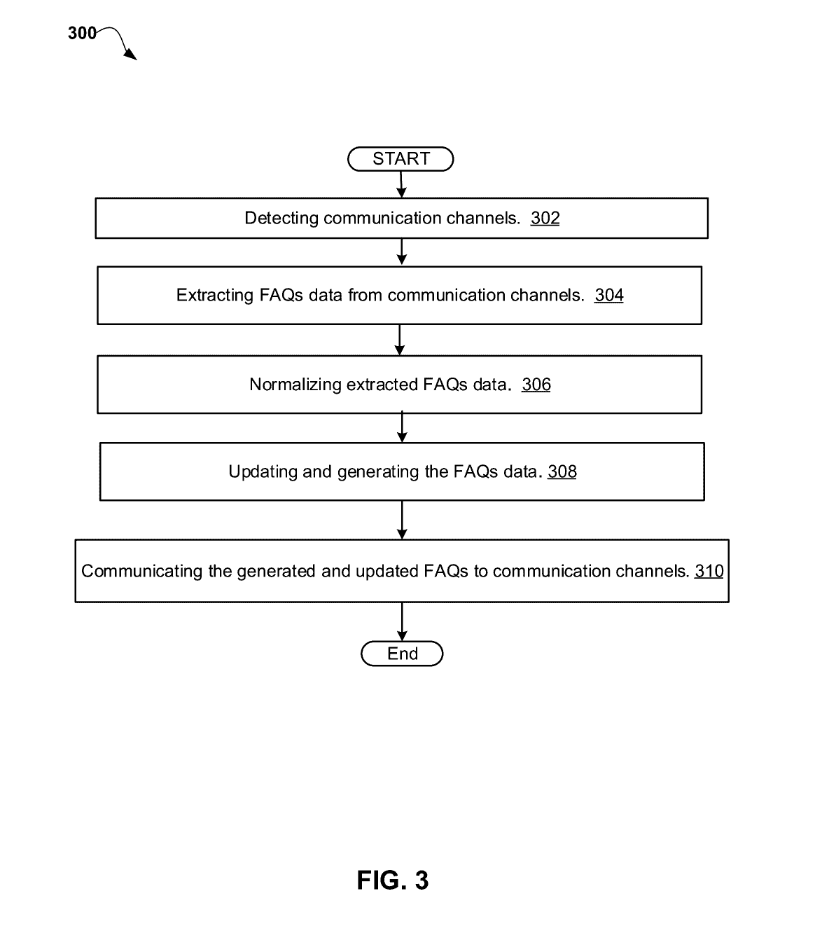

Referring now to FIG. 3, an operational flowchart 300 illustrating the steps carried out by a program for updating and generating frequently asked questions (FAQs) associated with different communication channels is depicted. At 302, the FAQs maintenance program 108A, 108B (FIG. 1) may detect communication channels. For example, and as previously described in FIG. 2, the FAQs maintenance program 108A, 108B (FIG. 1) may detect different communication channels such as call centers 202 (FIG. 2), websites 204 (FIG. 2), service kiosks 206 (FIG. 2), face-to-face interactions, gaming consoles, physical mail, and email applications.

Next, at 304, the FAQs maintenance program 108A, 108B (FIG. 1) may extract FAQs data from the detected communication channels. Specifically, the FAQs maintenance program 108A, 108B (FIG. 1) may extract the existing FAQs and answers data on the communication channels as well as detect and extract new questions posed by users on the communication channels. For example, the FAQs maintenance program 108A, 108B (FIG. 1) may extract FAQs data from a website 204 (FIG. 2) such as eBay® (eBay and all eBay—based trademarks and logos are trademarks or registered trademarks of eBay and/or its affiliates). Specifically, the FAQs maintenance program 108A, 108B (FIG. 1) may extract FAQs that exist on the eBay® website such as “what happens if an item is damaged or lost” and “how to report a seller”. Furthermore, the FAQs maintenance program 108A, 108B (FIG. 1) may detect and extract new questions posed by users such as questions searched for on the eBay® search bar and questions related to eBay® that are searched for using a search engine such as Google® (Google and all Google—based trademarks and logos are trademarks or registered trademarks of Google and/or its affiliates).

Then, at 306, the FAQs maintenance program 108A, 108B (FIG. 1) may normalize the extracted FAQs data. Specifically, the extracted FAQs data may be in different formats based on the type of communication channel. For example, the FAQs maintenance program 108A, 108B (FIG. 1) may extract FAQs data from the call center 202 (FIG. 2) that may be in the format of recorded conversations between customers and representatives, whereas the extracted FAQs data from the website 204 (FIG. 2) may be in the format of text queries. As such, the FAQs maintenance program 108A, 108B (FIG. 1) may use the FAQs data normalizer 210 (FIG. 2) to normalize the extracted FAQs data to a uniform format. For example, the FAQs maintenance program 108A, 108B (FIG. 1) may extract the FAQs data that is in the format of text queries from the website 204 (FIG. 2) and may use the voice recognition tool 208 (FIG. 2) to extract the FAQs data that is in the format of recorded conversations from the call center 202 (FIG. 2). Furthermore, the FAQs maintenance program 108A, 108B (FIG. 1) may use the FAQs data normalizer 210 (FIG. 2) to normalize the extracted FAQs data in the recorded conversation to a text query format such that the FAQs data from the call center 202 (FIG. 2) and the FAQs data from the website 204 (FIG. 2) may both be in a uniform text query format.

Next, at 308, the FAQs maintenance program 108A, 108B (FIG. 1) may update and generate FAQs data. As previously described in FIG. 2, the FAQs maintenance program 108A, 108B (FIG. 1) may use the FAQs data analyzer and generator 212 (FIG. 2) to perform reasoning and analysis on the extracted normalized FAQs data. Specifically, according to one implementation, the FAQs maintenance program 108A, 108B (FIG. 1) may use a FAQs data analyzer and generator 212 (FIG. 2) such as IBM Watson® (IBM Watson and all IBM Watson—based trademarks and logos are trademarks or registered trademarks of IBM and/or its affiliates) to perform the reasoning and analysis. Furthermore, as previously described at step 304, the FAQs maintenance program 108A, 108B (FIG. 1) may extract FAQs data from the communication channels 202, 204, 206 (FIG. 2) that may include existing FAQs and answers on the communication channels as well as new questions posed by users on the communication channels. Therefore, the FAQs maintenance program 108A, 108B (FIG. 1) may use the FAQs data analyzer and generator 212 (FIG. 2) to update the existing FAQs and answers as well as generate FAQs based on the new questions posed by users on the communication channels 202, 204, and 206 (FIG. 2). For example, the FAQs maintenance program 108A, 108B (FIG. 1) may extract and normalize FAQs data from a company's call center 202 (FIG. 2), website 204 (FIG. 2), and service kiosk 206 (FIG. 2). Thereafter, the FAQs maintenance program 108A, 108B (FIG. 1) may perform reasoning and analysis on the extracted and normalized FAQs data such as deciphering the FAQs, analyzing the FAQs for duplicated questions and answers, determining whether certain FAQs contain offensive language, updating the existing FAQs, and generating FAQs based on the extracted FAQ data.

Then, at 310, the FAQs maintenance program 108A, 108B (FIG. 1) may communicate the updated and generated FAQs to the communication channels 202, 204, 206 (FIG. 2). As previously described at step 308, the FAQs maintenance program 108A, 108B (FIG. 1) may use the FAQs data analyzer and generator 212 (FIG. 2) to update and generate FAQs data. Thereafter, the FAQs maintenance program 108A, 108B (FIG. 1) may use the FAQs data analyzer and generator 212 (FIG. 2) to communicate the updated and generated FAQs to the communication channels 202, 204, and 206 (FIG. 2). For example, the FAQs maintenance program 108A, 108B (FIG. 1) may use the FAQs data analyzer and generator 212 (FIG. 2) to update and generate FAQs associated with a company's communication channels such as a call center 202 (FIG. 2), a website 204 (FIG. 2), and a service kiosk 206 (FIG. 2). Then, the FAQs maintenance program 108A, 108B (FIG. 1) may use the FAQs data analyzer and generator 212 (FIG. 2) to communicate the updated and generated FAQs to the call center 202 (FIG. 2), the website 204 (FIG. 2), and the service kiosk 206 (FIG. 2) in their respective formats.

It may be appreciated that FIGS. 2 and 3 provide only illustrations of one implementation and does not imply any limitations with regard to how different embodiments may be implemented. Many modifications to the depicted environments may be made based on design and implementation requirements. For example, at step 308 (FIG. 3), the FAQs maintenance program 108A, 108B (FIG. 1) may also provide answers using the FAQs data analyzer and generator 212 (FIG. 2). Specifically, the FAQs maintenance program 108A, 108B (FIG. 1) may use the analyzing system of a FAQs data analyzer and generator 212 (FIG. 2) such as IBM Watson® to update and provide answers to existing FAQs and FAQs posed by users, whereby the updated and provided answers are checked against answers provided on the respective communication channels 202, 204, and 206 (FIG. 2). Thereafter, as previously described in step 310 (FIG. 3), the FAQs maintenance program 108A, 108B (FIG. 1) may communicate the updated and generated FAQs and answers to the communication channels 202, 204, 206 (FIG. 2).

FIG. 4 is a block diagram 400 of internal and external components of computers depicted in FIG. 1 in accordance with an illustrative embodiment of the present invention. It should be appreciated that FIG. 4 provides only an illustration of one implementation and does not imply any limitations with regard to the environments in which different embodiments may be implemented. Many modifications to the depicted environments may be made based on design and implementation requirements.

Data processing system 800, 900 is representative of any electronic device capable of executing machine-readable program instructions. Data processing system 800, 900 may be representative of a smart phone, a computer system, PDA, or other electronic devices. Examples of computing systems, environments, and/or configurations that may represented by data processing system 800, 900 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 (FIG. 1), and network server 112 (FIG. 1) include respective sets of internal components 800 a, b and external components 900 a, b illustrated in FIG. 4. Each of the sets of internal components 800 a, b includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828, the software program 114 (FIG. 1), the FAQs maintenance program 108A (FIG. 1) in client computer 102 (FIG. 1), and the FAQs maintenance program 108B (FIG. 1) in network server computer 112 (FIG. 1) are stored on one or more of the respective computer-readable tangible storage devices 830 for execution by one or more of the respective processors 820 via one or more of the respective RAMs 822 (which typically include cache memory). In the embodiment illustrated in FIG. 4, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800 a, b, also includes a R/W drive or interface 832 to read from and write to one or more portable computer-readable tangible storage devices 936 such as a CD-ROM, DVD, memory stick, magnetic tape, magnetic disk, optical disk or semiconductor storage device. A software program, such as a FAQs maintenance program 108A, 108B (FIG. 1), can be stored on one or more of the respective portable computer-readable tangible storage devices 936, read via the respective R/W drive or interface 832 and loaded into the respective hard drive 830.

Each set of internal components 800 a, b also includes network adapters or interfaces 836 such as a TCP/IP adapter cards, wireless Wi-Fi interface cards, or 3G or 4G wireless interface cards or other wired or wireless communication links. The FAQs maintenance program 108A (FIG. 1) and software program 114 (FIG. 1) in client computer 102 (FIG. 1), and the FAQs maintenance program 108B (FIG. 1) in network server 112 (FIG. 1) can be downloaded to client computer 102 (FIG. 1) from an external computer via a network (for example, the Internet, a local area network or other, wide area network) and respective network adapters or interfaces 836. From the network adapters or interfaces 836, the FAQs maintenance program 108A (FIG. 1) and software program 114 (FIG. 1) in client computer 102 (FIG. 1) and the FAQs maintenance program 108B (FIG. 1) in network server computer 112 (FIG. 1) are loaded into the respective hard drive 830. The network may comprise copper wires, optical fibers, wireless transmission, routers, firewalls, switches, gateway computers and/or edge servers.

Each of the sets of external components 900 a, b can include a computer display monitor 920, a keyboard 930, and a computer mouse 934. External components 900 a, b can also include touch screens, virtual keyboards, touch pads, pointing devices, and other human interface devices. Each of the sets of internal components 800 a, b also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

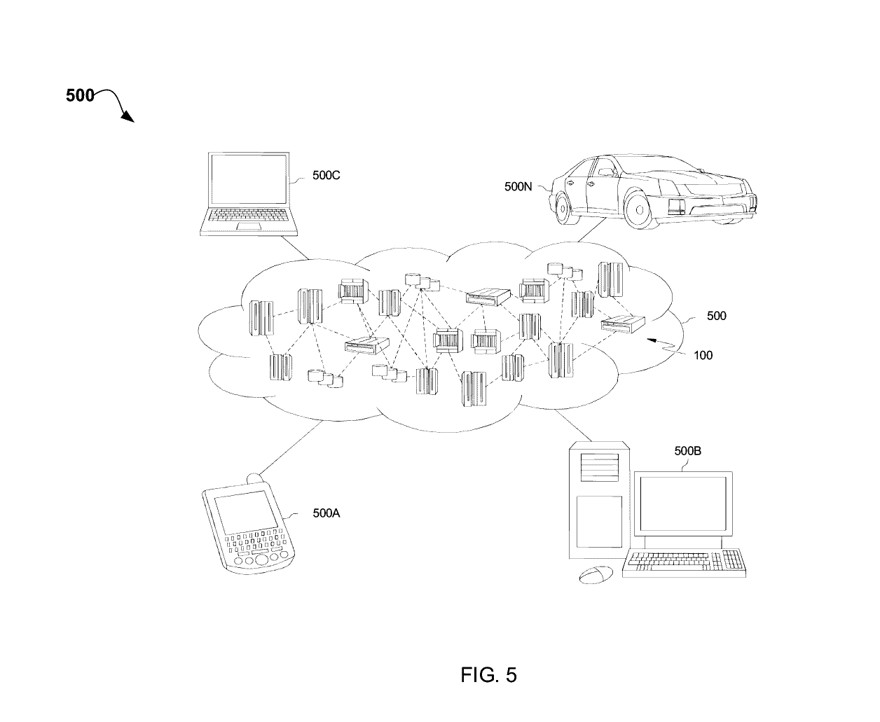

Referring now to FIG. 5, illustrative cloud computing environment 500 is depicted. As shown, cloud computing environment 500 comprises one or more cloud computing nodes 100 with which local computing devices used by cloud consumers, such as, for example, personal digital assistant (PDA) or cellular telephone 500A, desktop computer 500B, laptop computer 500C, and/or automobile computer system 500N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 500 to offer infrastructure, platforms and/or software as services for which a cloud consumer does not need to maintain resources on a local computing device. It is understood that the types of computing devices 500A-N shown in FIG. 5 are intended to be illustrative only and that computing nodes 100 and cloud computing environment 500 can communicate with any type of computerized device over any type of network and/or network addressable connection (e.g., using a web browser).

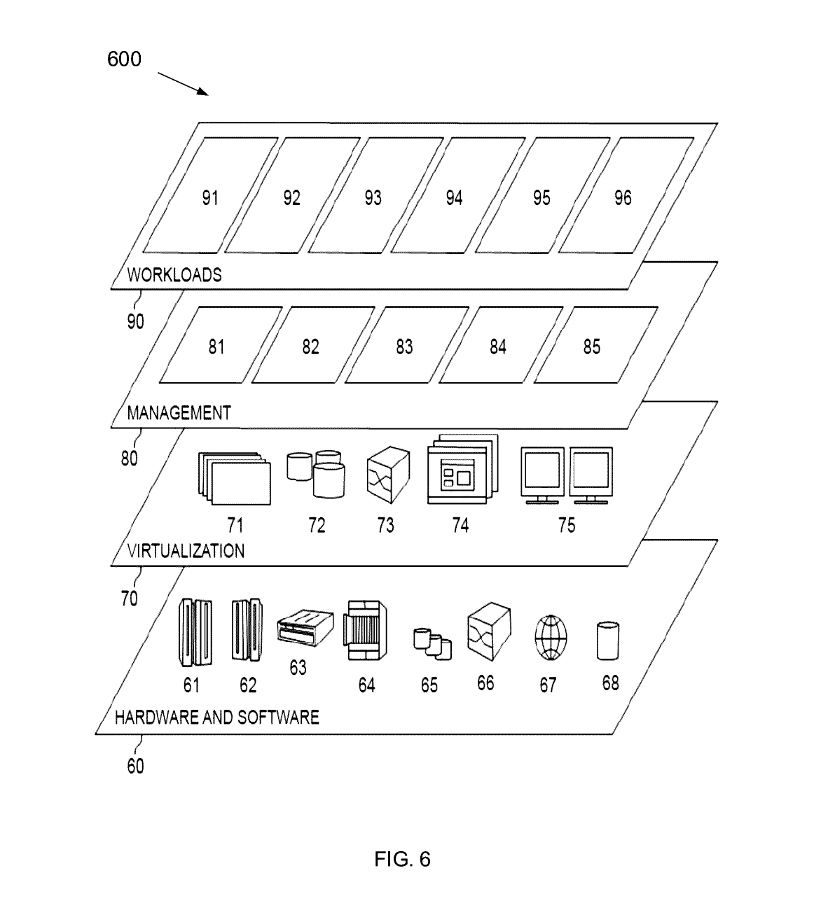

Referring now to FIG. 6, a set of functional abstraction layers 600 provided by cloud computing environment 500 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and FAQs Maintenance 96. A FAQs Maintenance Program 108A, 108B (FIG. 1) may be offered “as a service in the cloud” (i.e., Software as a Service (SaaS)) for applications running on mobile devices 102 (FIG. 1) and may update and generate FAQs associated with different communication channels.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method comprising:
detecting, by a FAQs maintenance program utilizing a processor, a website that includes a plurality of frequently asked questions (FAQs) in the form of text query and an audio query,
wherein the FAQs maintenance program is an application running on a server computer that is in connection with a client device via a communications network, and further the FAQs maintenance program interacts with one or more software products,
wherein the plurality of FAQs were inputted by a plurality of users using the website,
wherein the FAQs include a question and an answer to the question;
extracting the plurality of FAQs from the website;
normalizing, by a FAQs data normalizer, the extracted plurality FAQs that include audio query and text query into a uniform format;
performing, utilizing a natural language processor, reasoning and analytical techniques on the extracted and normalized plurality of FAQs;
searching for duplicate FAQs;
determining, by the natural language processor, that the extracted and normalized plurality of FAQs includes questions of the plurality of FAQs that include offensive content;
filtering the questions with offensive content from questions with inoffensive content;
replacing the offensive content with inoffensive content;
updating, by the FAQs maintenance program and based on the determining that the plurality of FAQs includes questions that include offensive content and further based on historical data from previous updates, the questions of the plurality of FAQs;
recording information associated with the updating into a database to be used in future updates; and
displaying the updated questions of the plurality of FAQs within the website.
